(19) United States
(12) Patent Application Publication
(10) Pub. No.: US 2002/0091572 A1
(43) Pub. Date: Jul. 11, 2002

(54) Prepaid service interface system and method

(76) Inventors: Carol Anderson, Bonita Springs, FL (US); Nirmalya Chattopadhyay, (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/825,297

(22) Filed: Apr. 2, 2001

Related U.S. Application Data
(60) Provisional application No. 60/193,680, filed on Mar. 31, 2000.

(51) Int. Cl. G06F 17/60

(52) U.S. Cl. 705/16

(57) ABSTRACT

The present invention provides a system and method for providing prepaid services. In architecture, the system includes logic for connecting to a network. Logic is used for requesting access realtime prepaid services, and logic also is used for acquiring access to the prepaid services. The present invention can also be viewed as a method for providing prepaid services. The method operates by connecting to a network, requesting access to realtime prepaid services, and acquiring access to the prepaid services.

### CROSS-REFERENCE TO RELATED APPLICATION

This application claims the benefit of U.S. Provisional Patent Application entitled “Prepaid Service Interface System,” filed Mar. 31, 2000 and having Ser. No. 60/193,680, which is entirely incorporated herein by reference.

### FIELD OF THE INVENTION

The present invention generally relates to computers and computer software, and more particularly to a system and method providing a prepaid service interface.

### DESCRIPTION OF RELATED ART

Typically, prepaid services are offered to subscribers utilizing a prepaid calling card. Normally, the customer buys a calling card and must dial a special access number, usually a 1-800 number in the United States, followed by a pin number and then the call number to complete an outgoing call. The customer may use this service when calling from any wire or wireless phone supported by the card provider. The typical prepaid calling card is generally not tied to a specific directory number or specific device. Furthermore, the prepaid calling card service generally does not support incoming calls.

In addition, typical prepaid calling card systems lack the ability to provide for a single view of the prepaid and postpaid customer data, with centralized data access and processing. Also lacking is the ability to switch from a prepaid to a postpaid customer and vice versa. Likewise, lacking is the ability to set up and activate prepaid and postpaid customers in real-time, since most prepaid calling cards are purchased at a point of sale terminal at a grocery store or other commercial establishment.

The typical prepaid calling card system also generally lacks the ability to look up the prepaid and postpaid calls made by the customer. This is generally because these cards are considered a commodity. Furthermore, the current systems generally lack the ability to provide data regarding customer call inquiries.

Thus, a heretofore-unaddressed need exists in the industry to address the aforementioned and/or other deficiencies and inadequacies.

### SUMMARY OF THE INVENTION

The present invention provides a system and method for a prepaid service system. Briefly described, in architecture, the system of the preferred embodiment can be implemented as follows. The system includes logic for connecting to a network. Logic is used for requesting access realtime prepaid services. Logic also is provided for acquiring access to the prepaid services.

The present invention can also be viewed as providing a prepaid service system. The method operates by (1) connecting to a network; (2) requesting access to realtime prepaid services; and (3) acquiring access to the prepaid services.

Other features and advantages of the present invention will become apparent to one with skill in the art upon examination of the following drawings and detailed description. It is intended that all such additional features and advantages be included herein within the scope of the present invention.

### BRIEF DESCRIPTION OF THE DRAWINGS

The accompanying drawings incorporated in and forming a part of the specification illustrate several aspects of the present invention, and together with the description, serve to explain the principles of the invention. Moreover, in the drawings, like reference numerals designate corresponding parts throughout the several views. In the drawings:

FIG. 1 is a block diagram illustrating an example of a network in which the prepaid system may be implemented.

FIG. 2 is a block diagram illustrating an example of a computer system utilizing the prepaid system, including the payment handling, prepaid accounts, call detail records, database, credit card management, tariffs, recharge and exploration management, voucher management, real-time rating, and the network interface of the present invention.

FIG. 3 is a block diagram illustrating an example of the architecture of the prepaid system and its interaction with other components, including a billing system.

### DETAILED DESCRIPTION OF THE PREFERRED EMBODIMENT

Reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications, and equivalents included within the spirit and scope of the invention as defined by the appended claims.

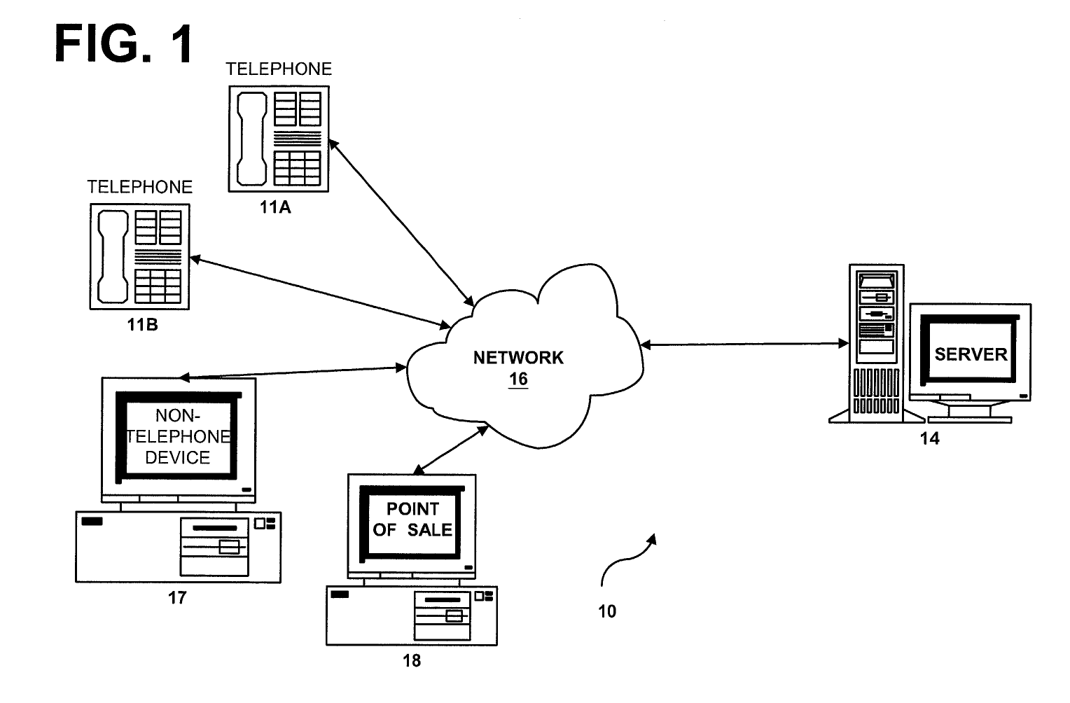

Referring now to the drawings, wherein like reference numerals designate corresponding parts throughout the drawings, FIG. 1 is a block diagram that portrays a diagram of a network that illustrates the flexibility, expandability, and platform independence in which the present prepaid system 50 may be implemented. Referring to FIG. 1, a series of telephones (11a, 11b) and terminals (17, 18) are connected to a server computer 14 via a network 16. The network 16 may be, for example, but is not limited to, a dial-in network, local area network (LAN), wide area network (WAN), public switched telephone network (PSTN), Intranet, Internet, Ethernet type networks, and the like. The telephones (11a, 11b) and terminals (17, 18) may be located within a LAN, WAN, PSTN, Intranet, Internet, Ethernet type networks, or the like. It should be noted that the number of client devices and server computers may differ from the number presently illustrated. Further, it should also be noted that, that the preferred embodiment of the invention describes the functionality provided by a server computer 14.

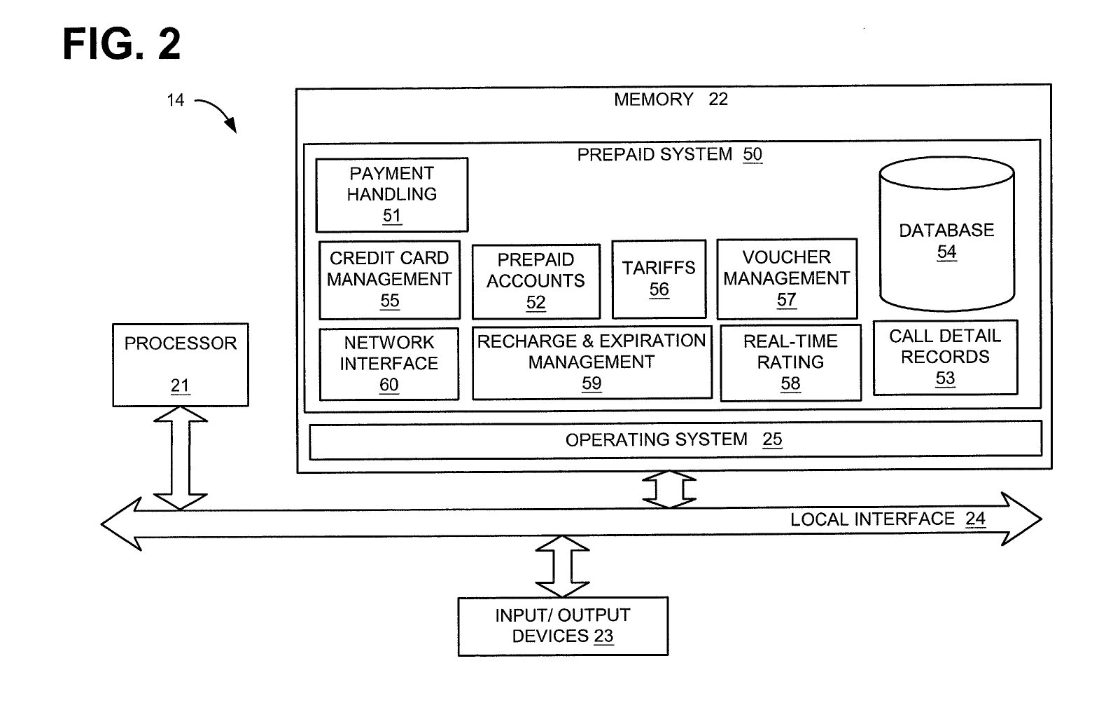

An example of a general-purpose computer that can implement the prepaid system of the present invention is shown in FIG. 2. The prepaid system, denoted by reference numeral 50, includes payment handling 51, prepaid accounts 52, call detail records 53, database 54, credit card management 55, tariffs 56, voucher management 57, real-time rating 58 and recharge & expiration management 59. The prepaid system 50 of the invention can be implemented in software (e.g., firmware), hardware, or a combination thereof. In one embodiment, the prepaid system 50 is implemented in software, as an executable program, and is executed by a special or general purpose digital computer, such as a personal computer (PC, IBM-compatible, Apple-compatible, or otherwise), workstation, minicomputer, personal digital assistant (PDA) or mainframe computer.

Generally, in terms of hardware architecture, as shown in FIG. 2, the server computer 14 include a processor 21, memory 22, and one or more input and/or output (I/O) devices 23 (or peripherals) that are communicatively coupled via a local interface 24. The local interface 24 can be, for example but not limited to, one or more buses or other wired or wireless connections, as is known in the art. The local interface 24 may have additional elements, which are omitted for simplicity, such as controllers, buffers (caches), drivers, repeaters, and receivers, to enable communications. Further, the local interface 24 may include address, control, and/or data connections to enable appropriate communications among the aforementioned components.

The processor 21 is a hardware device for executing software that can be stored in memory 22. The processor 21 can be virtually any custom made or commercially available processor, a central processing unit (CPU) or an auxiliary processor among several processors associated with the computer 14, and a semiconductor based microprocessor (in the form of a microchip) or a macroprocessor. Examples of suitable commercially available microprocessors are as follows: an 80x86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 22 can include any one or combination of volatile memory elements (e.g., random access memory (RAM, such as DRAM, SRAM, etc.)) and nonvolatile memory elements (e.g., ROM, hard drive, tape, CDROM, etc.). Moreover, the memory 22 may incorporate electronic, magnetic, optical, and/or other types of storage media. Note that the memory 22 can have a distributed architecture, where various components are situated remote from one another, but can be accessed by the processor 21.

The software in memory 22 may include one or more separate programs, each of which comprises an ordered listing of executable instructions for implementing logical functions. In the example of FIG. 2, the software in the memory 22 includes the prepaid system 50 and a suitable operating system (O/S) 25.

A non-exhaustive list of examples of suitable commercially available operating systems 25 is as follows: a Windows operating system from Microsoft Corporation, U.S.A., a Netware operating system available from Novell, Inc., U.S.A., an operating system available from IBM, Inc., U.S.A., any LINUX operating system available from many vendors or a UNIX operating system, which is available for purchase from many vendors, such as Hewlett-Packard Company, U.S.A., Sun Microsystems, Inc. and AT&T Corporation, U.S.A. The operating system 25 essentially controls the execution of other computer programs, such as the prepaid system 50, and provides scheduling, input-output control, file and data management, memory management, and communication control and related services.

The prepaid system 50 may be a source program, executable program (object code), script, or any other entity comprising a set of instructions to be performed. When a source program, then the program is usually translated via a compiler, assembler, interpreter, or the like, which may or may not be included within the memory 22, so as to operate properly in connection with the O/S 25. Furthermore, the prepaid system 50 can be written as (a) an object oriented programming language, which has classes of data and methods, or (b) a procedure programming language, which has routines, subroutines, and/or functions, for example but not limited to, C, C++, Pascal, BASIC, FORTRAN, COBOL, Perl, Java, and Ada.

The I/O devices 23 may include input devices, for example but not limited to, a keyboard, mouse, scanner, microphone, etc. Furthermore, the I/O devices 23 may also include output devices, for example but not limited to, a printer, display, etc. Finally, the I/O devices 23 may further include devices that communicate both inputs and outputs, for instance but not limited to, a modulator/demodulator (modem, for accessing another device, system, or network), a radio frequency (RF) or other transceiver, a telephonic interface, a bridge, a router, etc.

If the server 14, is a PC, workstation, or the like, the software in the memory 22 may further include a basic input output system (BIOS) (omitted for simplicity). The BIOS is a set of essential software routines that initialize and test hardware at startup, start the O/S 25, and support the transfer of data among the hardware devices. The BIOS is stored in ROM so that the BIOS can be executed when the server 14 is activated.

When the server 14 is in operation, the processor 21 is configured to execute software stored within the memory 22, to communicate data to and from the memory 22, and to generally control operations of the computer 14 pursuant to the software. The prepaid system 50 and the O/S 25 are read, in whole or in part, by the processor 21, perhaps buffered within the processor 21, and then executed.

When the prepaid system 50 is implemented in software, as is shown in FIG. 2, it should be noted that the prepaid system 50 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method. The prepaid system 50 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the prepaid system 50 is implemented in hardware, the prepaid system 50 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

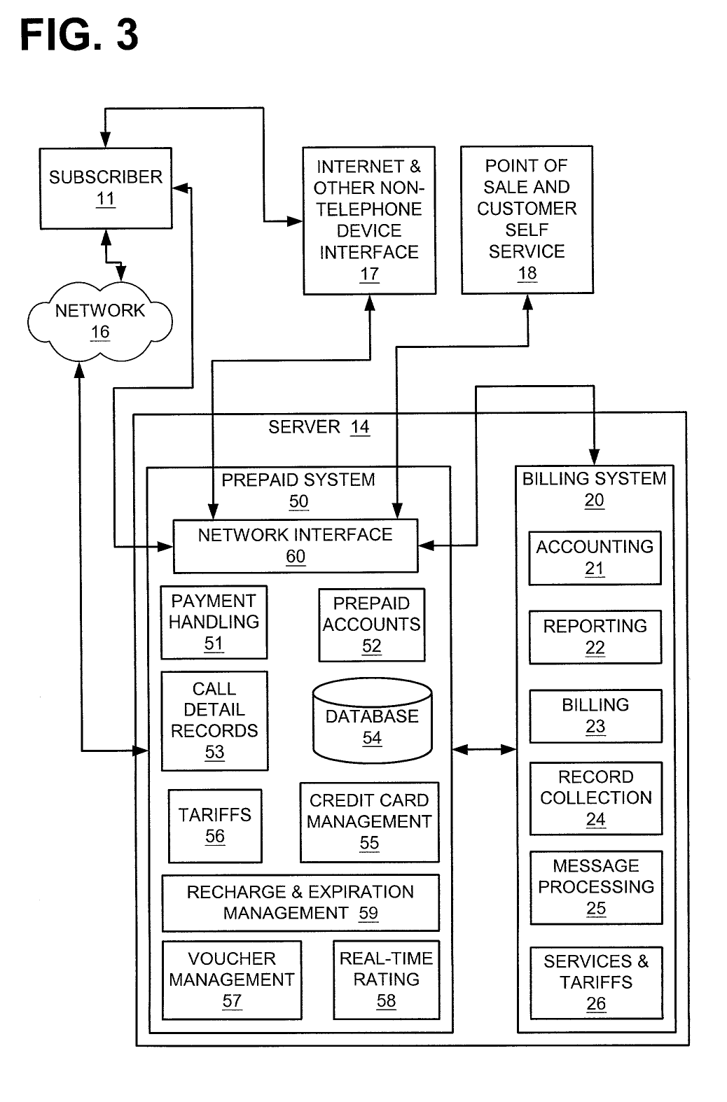

Illustrated in FIG. 3 is an example of an architecture of the prepaid system 50 interacting with other systems, such as a billing system 20, to provide a total prepaid package solution. The goal is to provide a common customer care interface for both prepaid and postpaid services, and to support additional options by providing an interface between the prepaid system 50 and a billing system 20. Another goal is to provide a single view for the prepaid and postpaid customer with centralized data accessing and processing. Still another goal is to enable a customer to switch easily from prepaid and postpaid service and from postpaid to prepaid service. Also included is the ability to set up activated prepaid or postpaid customers in real-time. In addition to the setup and activation of prepaid and postpaid customers, the system provides the ability to look up prepaid and postpaid calls for customer care inquiries. The integration of the prepaid system 50 and the billing system 20 also enables a user to replenish their prepaid service utilizing multiple interfaces. These multiple interfaces also permit the user to perform lookups of payments and balances on their prepaid and postpaid accounts.

Prepaid services are defined as, but are not limited to, prepaid telephone services, prepaid wireless services and prepaid calling cards. Prepaid services also provide customers with prepaid and postpaid services and balance adjustments that include initial payments, credits, replenishment on appropriate network elements in real-time. A customer will be able to perform an inquiry into the customer's prepaid balance through a real-time interface. The balance is a post-call balance, e.g., it is current with the completion of the last call. Historical data, i.e., prepaid rated calls and any events that impact the customer's account balance, are made available to the billing system 20 from the prepaid system 50 for inquiry and possible inclusion on customer statements. The individual function modules within the prepaid system 50 will now be discussed.

The first module is the payment handling module 51. The payment handling module 51 within the prepaid system 50 provides for support of options in addition to or instead of vouchers for replenishment, i.e., recharging of a prepaid account, such as cash, bank transfers, and credit cards. The payment handling module 51 provides support of replenishment from a direct debit, credit card, debit card, cash, or voucher through customer contact, either at a point of sale or through customer self-service functionality 18. Bank transfers of credit can be directly transmitted to the billing system 20, which are then processed and forwarded to the pay handling module 51 within the prepaid system 50. As previously discussed, replenishment may occur through a point of sale system and customer self-service 18 that is fed directly into the billing system 20 and is then accounted for within the payment handling module 51.

Customer replenishments of prepaid services may be handled by voucher or credit card through an Internet or other non-telephone device interface 17 into the prepaid system 50.

The prepaid account module 52 provides the ability to set up, activate and maintain customer data and a mobile number. The set-up and activation of customer data may occur through the Internet or other non-telephone device interface 17 or at point of sale and customer self service interface 18. The point of sale or customer self service module 18 also enables the customer to review prepaid call histories from the call detail records that are produced for each and every call. These call detail records are stored in database 54 and are processed by the call detail records module 53. The point of sale and customer self-service interface 18 also enables a customer to review prepaid payment history, credits and adjustments, as indicated by event detail records from within the prepaid system 50, regardless of their origin of the transaction. The point of sale and customer self-service interface 18 also enables the prepaid system 50 to accept initial payments and replenishments via credit card, direct debit, or prepaid voucher. All point of sale and customer self-service interaction of the customer with the prepaid system 50 is enabled through the network interface 60 that is herein defined in further detail.

The network interface 60 involves bi-directional communication with network elements, such as the subscriber via telephone, through the Internet or other non-telephone device interface 12, through the point of sale and customer self-service interface 18 and via a telephone call from the subscriber 11 through network 17.

The tariffs module 56 provides the prepayment system 50 with the ability to provide prepaid and postpaid tariff model data, and to store this tariff model data. This stored data can then provide later access by the billing system 20 and the subscriber 11. The tariff models within the tariff module 56 can provide real-time rating that occurs while a prepaid call is in process, and a postpaid rating that occurs sometime after completion of a postpaid call. The tariffs module 56 may also include processes for mapping and synchronizing tariff data stored within database 54 in the prepaid system 50.

The credit card management module 55 provides for the functionality where only physical prepaid cards are required for use by the prepaid service, such as in the case of prepaid calling cards. The credit card management module 55 provides for ordering prepaid cards from a card vendor and for distributing these prepaid cards to point of sale dealers. The credit card management module 55 also provides for the assignment and administration of the personal identification number (PIN) for use during authentication for each time the prepaid card is used. The credit card management module 55 also provides a directory number assignment to establish a direct link between the prepaid calling card and an assigned telephone number. The credit card management module 55 also provides for the ability to mass pre-activate prepaid cards on the prepaid system 50.

The voucher management module 57 may be used to replenish or recharge a prepaid card. These vouchers may be used in conjunction with the prepaid wireless service and prepaid calling cards. Replenishment via voucher may be initiated by the subscriber telephone 11 through customer service representative access into the billing system 20 through a point of sale system 18 and its interface to the billing 23 module. The voucher management module 57 may also provide replenishments of prepaid cards through a direct interface into the prepaid system 50 via the Internet or other non-telephone device interface 17. The voucher management module 57 further provides for the ordering and distributing of numbered vouchers to customers. In addition, the voucher management module may provide for voucher fraud management in the case of loss or theft of individual cards or batches of prepaid calling cards. The assignment and administration of PIN numbers that are linked to vouchers and are used for credit card validation when replenishing of a prepaid account are also processed by the voucher management module 57.

Real-time rating module 58 provides for the ability of the prepaid system 50 to establish inbound and outbound ratings of services provided. The real-time rating module 58 provides for rating of services by minutes, units and multiple currencies. The real-time rating module 58 can further establish the rate for a particular service based upon the dialed number, or call origin, i.e., a pay phone. The real-time rating module 58 enables the rates to be configured in billing increments during a call and automatically reduces a customer balance in real-time. The real-time rating module 58 also provides for the ability of the prepaid system 50 to disconnect a call when the prepaid card acquires a zero balance. The real-time rating module 58 further provides for the ability to rate the service for multiple simultaneous calls, i.e., conference of multiple party calls. It is understood that the rate for a single party-to-party call is substantially different from a multi-party call, such as five parties in different locations. The real-time rating module 58 further provides for the restricting of calling areas serviceable for the prepaid card. Also provided by the real-time rating module 58 is the ability to provide talk time, expiration date and balance information to the customer. A low balance warning may be provided to a customer and can be a whisper tone in real-time. This will enable a customer to terminate a call prior to the real-time rating module 58 disconnecting the service when the prepaid card reaches a zero balance.

The recharging and expiration management module 59 provides for the ability to handle the prepaid cards and vouchers that have expiration periods, as defined by a network operator. An example of the expiration valid periods, in which the prepaid credit cards can be used, can be established in records maintained within database 54. The types of records include the valid period for which a prepaid card is valid, a no credit period in which no chargeable calls are permitted for the prepaid card and a recharge only period when only replenishment of the prepaid calls are permitted. The recharge and expiration management module 59 further provides for the ability to bar and activate services at appropriate expiration points, as required by the network operator, via the network interface 60, in the prepayment system 50. The recharge and expiration management module 59 further provides for the adjusting of expiration dates through administration or when a replenishment of a prepaid card occurs.

The example billing system 20 is a standard billing system that provides for the accounting of balances via the accounting module 21 and the reporting of those balances utilizing the reporting module 22. A billing module 23 is capable of creating bills to send to customers. The message processing module 25 is utilized in the rating of postpaid calls, by either re-rating them or passing the postpaid calls unrated through the billing system to the other required modules. The message processing module 25 also maintains a call history and prepaid event history in the billing system. The services and tariffs process module 26 provides prepaid and postpaid tariff model administration and stores these models for access by their rated functions. The service and tariffs process module 26 may also include processing for mapping and synchronizing tariff data stored on both the prepaid system 50 and the billing system 20.

The foregoing description has been presented for purposes of illustration and description. It is not intended to be exhaustive or to limit the invention to the precise forms disclosed. Modifications or variations are possible in light of the above teachings.

The embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

What is claimed is:

1. A system for providing prepaid services, comprising:
means for connecting to a network;
means for requesting access to realtime prepaid services; and
means for acquiring access to the prepaid services.

2. The system of claim 1, further comprising:
means for recharging a prepaid account for the prepaid services.

3. The system of claim 2, wherein said means for recharging further comprises:
means for using a credit card to recharge the prepaid account for the prepaid services.

4. The system of claim 1, further comprising:
means for reviewing at least one transaction of the prepaid account for the prepaid services.

5. The system of claim 1, further comprising:
means for switching from the prepaid services to postpaid services.

6. The system of claim 1, further comprising:
means for providing access to the prepaid services through a point of sale device.

7. The system of claim 1, further comprising:
means for providing data changes to a billing system.

8. A method for providing prepaid services, said method comprising the steps of:
connecting to a network;
requesting access to realtime prepaid services; and
acquiring access to the prepaid services.

9. The method of claim 8, further comprising the step of:
recharging a prepaid account for the prepaid services.

10. The method of claim 9, wherein the recharging step further comprises the step of:
using a credit card to recharge the prepaid account for the prepaid services.

11. The method of claim 8, further comprising the step of:
reviewing at least one transaction of the prepaid account for the prepaid services.

12. The method of claim 8, further comprising the step of:
switching from the prepaid services to postpaid services.

11. The method of claim 8, further comprising the step of:
creating a prepaid account for the prepaid services.

12. The method of claim 8, wherein the acquiring access step further comprises the step of:
providing access to the prepaid services through a point of sale device.

13. The method of claim 8, further comprising the step of:
providing data changes to a billing system.

14. A computer readable medium for providing prepaid services, comprising:
logic for connecting to a network;
logic for requesting access to realtime prepaid services; and
logic for acquiring access to the prepaid services.

15. The computer readable medium of claim 14, further comprising:
logic for recharging a prepaid account for the prepaid services.

16. The computer readable medium of claim 15, wherein the logic for recharging further comprises:
logic for using a credit card to recharge the prepaid account for the prepaid services.

17. The computer readable medium of claim 14, further comprising:
logic for reviewing at least one transaction of the prepaid account for the prepaid services.

18. The computer readable medium of claim 14, further comprising:
logic for switching from the prepaid services to postpaid services.

19. The computer readable medium of claim 14, further comprising:
logic for creating a prepaid account for the prepaid services.

20. The computer readable medium of claim 14, further comprising:
logic for providing access to the prepaid services through a point of sale device.
